(19) United States
(12) Patent Application Publication
(10) Pub. No.: US 2022/0353621 A1
(43) Pub. Date: Nov. 3, 2022

(54) SILICON MICROPHONE

(71) Applicant: AAC ACOUSTIC TECHNOLOGIES (SHENZHEN) CO., LTD., Shenzhen (CN)

(72) Inventors: Kaijie Wang, Shenzhen (CN); Linlin Wang, Shenzhen (CN)

(21) Appl. No.: 17/566,611

(22) Filed: Dec. 30, 2021

(30) Foreign Application Priority Data
Apr. 29, 2021 (CN) 202120919671.3

(51) Int. Cl. H04R 19/04; H04R 7/02

(52) U.S. Cl. CPC H04R 19/04; H04R 7/02

(57) ABSTRACT

One of the main objects of the present invention is to provide a silicon microphone that is reasonably designed and can effectively improve electroacoustic performance. To achieve the above-mentioned objects, the present invention provides a silicon microphone including a substrate with a back cavity; and a capacitor system attached to and insulated from the substrate. The capacitor system includes a diaphragm and a back plate spaced from the diaphragm. At least one through hole is formed in the back plate. The diaphragm includes a vibration part in a middle thereof and a fixed part surrounding and spaced from the vibration part by a first slit. An orthographic projection of the vibration part on the substrate partially overlaps with the substrate thereby forming a second slit between the vibration part and the substrate and communicating with the first slit and the back cavity, respectively.

### FIELD OF THE PRESENT DISCLOSURE

The present invention relates to electroacoustic transducers, and more particularly to silicon microphone for converting sounds into electrical signals.

### DESCRIPTION OF RELATED ART

Micro-Electro-Mechanical System (MEMS) microphone is a kind of electric energy sound converter made by micro-machining technology. Because it is made of silicon-substrated semiconductor materials, it is also called silicon microphone, which has the characteristics of small size, good frequency response characteristics, and low noise. With the development of smaller, lighter and thinner electronic devices, MEMS microphones are more and more widely used in these devices.

As shown in FIG. 1, a related silicon microphone 10 includes a substrate 12 with a back cavity 11 and a capacitor system arranged on the substrate 12. The capacitor system includes a diaphragm 13 and a back plate 14 spaced apart from the diaphragm 13. A plurality of through holes 15 are provided on the back plate 14. A slit 16 is provided on the diaphragm 13. The air flow passes through the back cavity 11 and directly exits through the slit 16.

The low frequency attenuation of silicon microphone is an important performance indicator of silicon microphone. Reducing low attenuation can also reduce silicon microphone noise. When designing a silicon microphone diaphragm with legs, it is inevitable to design a vent groove. Air flow will enter the back cavity from the front cavity through the vent groove, thereby increasing the low attenuation.

In view of the above-mentioned problems, it is necessary to propose a silicon microphone that is reasonably designed and can effectively improve the above-mentioned problems.

### SUMMARY OF THE PRESENT INVENTION

One of the main objects of the present invention is to provide a silicon microphone that is reasonably designed and can effectively improve electroacoustic performance.

To achieve the above-mentioned objects, the present invention provides a silicon microphone including a substrate with a back cavity; and a capacitor system attached to and insulated from the substrate. The capacitor system includes a diaphragm and a back plate spaced from the diaphragm. At least one through hole is formed in the back plate. The diaphragm includes a vibration part in a middle thereof and a fixed part surrounding and spaced from the vibration part by a first slit.

An orthographic projection of the vibration part on the substrate partially overlaps with the substrate thereby forming a second slit between the vibration part and the substrate and communicating with the first slit and the back cavity, respectively.

In addition, a sidewall of the back cavity is closer to a center of the back cavity than the first slit, for forming an overlapping area between the orthographic projection of the vibration part and the substrate.

In addition, the silicon microphone includes a plurality of the at least one through holes, wherein an orthographic projection of the first slit on the back plate falls on an outer side of the outermost through hole.

In addition, a distance between a part of the back plate corresponding to the first slit and the diaphragm, is smaller than a distance between other parts of the back plate and the diaphragm.

In addition, a distance between a part of the substrate corresponding to the first slit and the diaphragm is smaller than a distance between other parts of the substrate and the diaphragm.

In addition, an area where the orthographic projection of the vibration part on the substrate overlaps the substrate is covered by an anti-absorption film structure.

In addition, the anti-absorption film structure includes a recess formed in a side of the vibration part facing the substrate.

Or, the anti-absorption film structure includes a recess formed in a side of the substrate facing the vibration part.

### BRIEF DESCRIPTION OF THE DRAWINGS

Many aspects of the exemplary embodiments can be better understood with reference to the following drawings. The components in the drawing are not necessarily drawn to scale, the emphasis instead being placed upon clearly illustrating the principles of the present disclosure.

FIG. 1 is a cross-sectional view of a related silicon microphone.

FIG. 2 is a cross-sectional view of a silicon microphone in accordance with a first embodiment of the present invention.

FIG. 3 is a cross-sectional view of a silicon microphone in accordance with a second embodiment of the present invention.

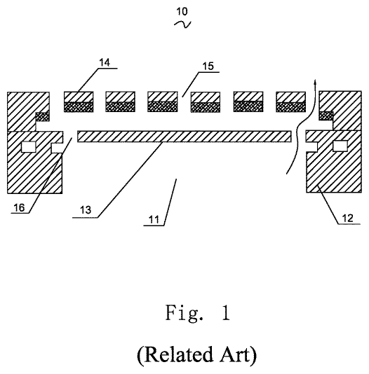

### DETAILED DESCRIPTION OF THE EXEMPLARY EMBODIMENTS

The present disclosure will hereinafter be described in detail with reference to exemplary embodiments. To make the technical problems to be solved, technical solutions and beneficial effects of the present disclosure more apparent, the present disclosure is described in further detail together with the figures and the embodiments. It should be understood the specific embodiments described hereby are only to explain the disclosure, not intended to limit the disclosure.

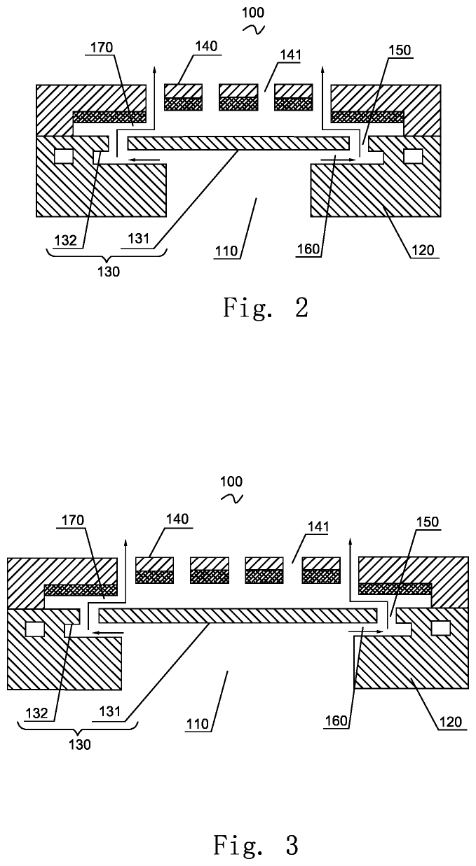

As shown in FIGS. 2-3, the present invention provides a silicon microphone 100, which includes a substrate 120 with a back cavity 110, and a capacitor system arranged on the substrate 120 and insulated from the substrate 120. The capacitor system includes a diaphragm 130 and a back plate 140 that is spaced apart from the diaphragm 130. At least one through hole 141 is provided on the back plate 140. The diaphragm 130 includes a vibration part 131 in the middle and a fixed part 132 surrounding the periphery of the vibration part 131. The vibration part 131 and the fixed part 132 are separated by a first slit 150. The orthographic projection of the vibration part 131 on the substrate 120 and the substrate 120 have a partial overlap area, so as to form a second slit 160 between the vibration part 131 and the substrate 120. The second slit 160 communicates with the first slit 150 and the back cavity 110 respectively.

It should be noted that substrate 120 is made of silicon-substrated semiconductor materials. The back cavity 110 runs through the substrate 120 setting. The back cavity 110 may be formed by a bulk silicon micromachining process or etching. The diaphragm 130 can be rectangular, circular, elliptical, and other shapes, and the embodiment is not specifically limited. The diaphragm 130 is connected to the substrate 120 through the first insulation layer (not shown in the figure). The back plate 140 is connected to the diaphragm 130 through a second insulation layer (not shown in the figure). There may be multiple through holes 141 on the back plate 140 to communicate with the external environment.

When the silicon microphone 100 is powered on, the back plate 140 and the diaphragm 130 will be charged with opposite polarities to form a capacitor. When diaphragm 130 vibrates under the action of sound waves. The distance between the diaphragm 130 and the back plate 140 will change. As a result, the capacitance of the capacitor system is changed, and the sound wave signal is converted into an electric signal to realize the corresponding function of the microphone.

As shown in FIG. 2, the orthographic projection of the vibration part 131 on the substrate 120 and the substrate 120 are partially overlapped to form a second slit 160 between the vibration part 131 and the substrate 120. The sidewall of the back cavity 110 is away from the first slit 150, that is, the volume of the back cavity 110 is reduced, so that the vibration part 131 of the diaphragm 130 and the substrate 120 may have a partially overlapping area to form the second slit 160. In this way, the airflow flowing through the first slit 150 will pass through the second slit 160 first, thereby increasing the air leakage damping and reducing low attenuation.

As shown in FIG. 3, the first slit 150 is away from the back cavity 110, that is, the area of the vibration part 131 of the diaphragm 130 increases. The first slit 150 moves away from the back cavity 110, so that the vibration part 131 of the diaphragm 130 and the substrate 120 are partially overlapped to form a second slit 160. In this way, the airflow flowing through the first slit 150 will pass through the second slit 160 first, thereby increasing the vent damping and reducing low attenuation.

As shown in FIGS. 2-3, a plurality of through holes 141 are provided on the back plate 140 at intervals. The orthographic projection of the first slit 150 on the back plate 140 falls on the outside of the outermost through hole 141. In this way, the part of the back plate 140 near the outermost through hole 141 and the vibration part 131 can have a partially overlapping area. In order to form the third slit 170, the air flow is discharged through the second slit 160, the first slit 150 and the third slit 170 in sequence. It can further increase the vent damping and reduce the low attenuation.

In order to further reduce the low attenuation, preferably, the part of the back plate 140 close to the first slit 150 extends toward the first slit 150. That is, the height of the overlapping area between the back plate 140 and the vibration part 131 is reduced. The distance between the part of the back plate 140 corresponding to the first slit 150 and the diaphragm is smaller than the distance between the other parts of the back plate and the diaphragm. In order to reduce the height of the third slit 170, the damping of the third slit 170 is further increased, and the low attenuation is further reduced.

Similarly, in order to further reduce the low attenuation, the portion of the substrate 120 close to the first slit 150 extends toward the first slit 150. That is, the interval height of the overlapping area of substrate 120 and vibration part 131 is reduced. The distance between the part of the substrate corresponding to the first slit and the diaphragm is smaller than the distance between the other parts of the substrate and the diaphragm. In order to reduce the height of the second slit 160, the damping of the second slit 160 is further increased, and the low attenuation is further reduced.

As shown in FIGS. 2-3, the overlapping area of substrate 120 and vibration part 131 is provided with an anti-absorption film structure (not shown in the figure). Prevent substrate 120 and vibration part 131 from being attracted together when silicon microphone 100 is working. Specifically, a recess may be provided on the side of the vibration part 131 facing the substrate 120, or a recess may be provided on the side of the substrate 120 facing the vibration part 131. Or, recesses are set on both the substrate 120 and the vibration part 131 mentioned above, this embodiment does not make specific restrictions.

It should be noted that the above-mentioned related structures are applicable to silicon microphones with top sounding or bottom sounding.

It is to be understood, however, that even though numerous characteristics and advantages of the present exemplary embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms where the appended claims are expressed.

What is claimed is:

1. A silicon microphone including:
a substrate with a back cavity;
a capacitor system attached to and insulated from the substrate, including a diaphragm and a back plate spaced from the diaphragm;
at least one through hole formed in the back plate; wherein
the diaphragm includes a vibration part in a middle thereof and a fixed part surrounding and spaced from the vibration part by a first slit;
an orthographic projection of the vibration part on the substrate partially overlaps with the substrate thereby forming a second slit between the vibration part and the substrate and communicating with the first slit and the back cavity, respectively.

2. The silicon microphone as described in claim 1, wherein, a sidewall of the back cavity is closer to a center of the back cavity than the first slit, for forming an overlapping area between the orthographic projection of the vibration part and the substrate.

3. The silicon microphone as described in claim 1 including a plurality of the at least one through holes, wherein an orthographic projection of the first slit on the back plate falls on an outer side of the outermost through hole.

4. The silicon microphone as described in claim 1, wherein, a distance between a part of the back plate corresponding to the first slit and the diaphragm, is smaller than a distance between other parts of the back plate and the diaphragm.

5. The silicon microphone as described in claim 1, wherein, a distance between a part of the substrate corresponding to the first slit and the diaphragm is smaller than a distance between other parts of the substrate and the diaphragm.

6. The silicon microphone as described in claim 1, wherein, an area where the orthographic projection of the vibration part on the substrate overlaps the substrate is covered by an anti-absorption film structure.

7. The silicon microphone as described in claim 6, wherein, the anti-absorption film structure includes a recess formed in a side of the vibration part facing the substrate.

8. The silicon microphone as described in claim 6, wherein, the anti-absorption film structure includes a recess formed in a side of the substrate facing the vibration part.
